(19) United States
(12) Patent Application Publication
(10) Pub. No.: US 2007/0217384 A1
(43) Pub. Date: Sep. 20, 2007

(54) Wireless LAN mobile station, wireless LAN system, and method and program of controlling handover

(75) Inventor: Yukio Mitani, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/723,201

(22) Filed: Mar. 16, 2007

(30) Foreign Application Priority Data
Mar. 16, 2006 (JP) 073223/2006

(51) Int. Cl. H04Q 7/24

(52) U.S. Cl. 370/338

(57) ABSTRACT

A wireless LAN mobile station is capable of decreasing the frequency of handovers. The wireless LAN mobile stations 1-1 to 1-N are configured to calculate the number of executing the handover processes in unit time and change a threshold value serving as a criterion for executing the handover process on the basis of the calculated number of handovers.

### BACKGROUND OF THE INVENTION

1. Field of the Invention

The present invention relates to a wireless LAN system including a plurality of wireless LAN base stations and a plurality of wireless LAN mobile stations, and more particularly, to wireless LAN mobile stations decreasing frequency of handovers, a wireless LAN system including the wireless LAN mobile stations, and a method and a program for controlling the handovers of the wireless LAN mobile stations.

2. Description of the Related Art

Recently, a wireless LAN (local area network) system represented by IEEE (Institute of Electrical and Electronics Engineers) 802.11x (“x” refers to a, b, g, or the like) is widely used. As shown in FIG. 1, the wireless LAN system includes wireless LAN mobile stations 1-1 to 1-N (N is an arbitrary integer), wireless LAN base stations 10-1 to 10-N, and a centralized management and control device 20. The device 20 controls wireless LAN base stations 10-1 to 10-N so that the wireless LAN base stations 10-1 to 10-N communicate with the wireless LAN mobile stations 1-1 to 1-N located within a coverage area (cell).

When the user of a wireless LAN mobile station 1-1 shown in FIG. 2 has moved from position “A”, where the mobile station 1-1 wirelessly communicates with a first wireless LAN base station 10-1, to a position “B”, where the mobile station 1-1 wirelessly communicates with a second wireless LAN base station 10-2, and the received signal strength indicator (RSSI) of a radio signal that the wireless LAN mobile station 1-1 has received from the first wireless LAN base station 10-1 has become weak, the wireless LAN mobile station 1-1 executes a handover process. Then, the wireless LAN mobile station 1-1 breaks the connection (association) with the first wireless LAN base station 10-1 that provides a weaker RSSI and then makes a connection (association) with the second wireless LAN base station 10-2 that provides a stronger RSSI.

The term “handover” refers to a switching control for continuing communication for the wireless LAN mobile station 1-1 to 1-N when the wireless LAN mobile station 1-1 to 1-N moves from the coverage area (cell) of the first wireless LAN base station 10-1 to the coverage area (cell) of the second wireless LAN base station 10-2 in a wireless LAN area composed of a plurality of coverage areas (cells) of the wireless LAN base stations 10-1 to 10-N.

Specifically, as shown in FIG. 2, when the wireless LAN mobile station 1-1 has moved from the position “A” to the position “B”, and the value of the received signal strength indicator (RSSI) of the radio signal received from the first wireless LAN base station 10-1 with which the wireless LAN mobile station 1-1 is currently communicating has decreased to a value equal to or smaller than a threshold value that serves as a criterion for executing the handover, the wireless LAN mobile station 1-1 searches for a nearby second wireless LAN base station 10-2 that provides a stronger RSSI. When the wireless LAN mobile station 1-1 has discovered a second wireless LAN base station 10-2 that provides a stronger RSSI, the wireless LAN mobile station 1-1 makes adjustments to the second wireless LAN base station 10-2 so as to switch the connection from the first wireless LAN base station 10-1 to the second wireless LAN base station 10-2, thereby preventing the wireless LAN mobile station 1-1 from being left disconnected.

The wireless LAN mobile stations 1-1 to 1-N should make handovers at appropriate timing since voice communication is interrupted for several milliseconds during the handover process.

Next, a series of operations performed by the wireless LAN system shown in FIG. 1 in the handover process will be described with reference to FIG. 3. FIG. 3 is a diagram showing exemplary operations performed by the wireless LAN system shown in FIG. 1 in the handover process. In the exemplary operations, it is assumed that the wireless LAN system shown in FIG. 1 is based on the IEEE 802.11 standard.

First, one of the wireless LAN mobile stations 1-1 to 1-N transmits a probe request signal to the first wireless LAN base station 10-1 (step A1). Upon receiving the probe request signal from the mobile station, the base station 10-1 transmits a probe response signal to the mobile station (step A2).

Upon receiving the probe response signal, the mobile station recognizes that some wireless LAN base station can establish communication with the mobile station, and transmits an authentication request signal to the base station 10-1 (step A3). Upon receiving the authentication request signal from the mobile station, the base station 10-1 transmits an authentication response signal to the mobile station (step A4).

Upon receiving the authentication response signal, the mobile station transmits an association request signal to the base station 10-1 and tries to establish communication with the base station 10-1 (step A5). Upon receiving the association request signal from the mobile station, the base station 10-1 transmits an association response to the mobile station and permits the mobile station to be associated with the base station 10-1 (step A6). With this arrangement, the mobile station can be associated with the base station 10-1, and a communication between the mobile station and the base station 10-1 is performed (step A7).

When the mobile station determines that the received signal strength indicator (RSSI) of the radio signal received from the base station 10-1 decreased to a value equal to or smaller than a threshold value serving as a criterion for executing the handover process (step A8), the mobile station executes the handover process and searches for other wireless LAN base stations 10-2 to 10-N that provide a stronger RSSI. At this time, the mobile station sequentially transmits probe request signals to each of radio channels defined by the IEEE 802.11 standard and performs a scanning operation on other wireless LAN base stations (step A9). In this way, the second wireless LAN base station 10-2 can receive a probe request signal from the mobile station.

Upon receiving the probe request signal from the mobile station, the base station 10-2 transmits a probe response signal to the mobile station (step A10). Upon receiving the probe response signal, the mobile station recognizes that some base station can establish communication with the mobile station, and transmits an authentication request signal to the base station 10-2 (step A11). Upon receiving the authentication request signal from the mobile station, the base station 10-2 transmits an acknowledgement response signal to the mobile station (step A12).

Upon receiving the acknowledgement response signal from the base station 10-2, the mobile station transmits an association request signal to the base station 10-2 and asks the base station 10-2 to establish communication with the mobile station (step A13). Upon receiving the association request signal from the mobile station, the base station 10-2 transmits an association response to the mobile station and permits the mobile station to be associated with the base station 10-2 (step A14). With this arrangement, the mobile station can be associated with the base station 10-2, and a communication between the mobile station and the base station 10-2 is performed (step A15).

In this way, when the mobile station determines that the received signal strength indicator (RSSI) of the radio signal received from the base station 10-1 is decreased to a value equal to or smaller than a threshold value serving as a criterion for executing the handover process, the mobile station executes the handover process and seeks for other wireless LAN base stations 10-2 to 10-N that provide a stronger RSSI. Then, when the mobile station performs a scanning operation on the wireless LAN base stations 10-2 to 10-N and finds the base station 10-2 that provides a stronger RSSI, the mobile station makes a connection (association) with the base station 10-2 that provides a stronger RSSI.

The wireless LAN base stations 10-1 to 10-N are installed in such a manner that coverage areas (cells) of wireless LAN base stations overlaps. It is desirable to set the received signal strength indicator (RSSI) value to a value equal to or greater than a threshold value (for example, −74 dBm to −68 dBm) serving as a criterion for executing the handover process.

However, since the wireless LAN base stations 10-1 to 10-N are installed in various environmental conditions, the value of received signal strength indicator (RSSI) transmitted from the wireless LAN base stations 10-1 to 10-N to the wireless LAN mobile stations 1-1 to 1-N may vary in accordance with the environmental conditions of the wireless LAN base stations 10-1 to 10-N. As a result, the wireless LAN mobile stations 1-1 to 1-N may execute the handover process unnecessarily frequently because of the variation in the RSSI value. This phenomenon is due to the high frequency used in the wireless LAN system, around 2.4 GHz or 5 GHz, and the radio wave tends to travel straight forward. For example, when an obstacle is present between the wireless LAN base stations 10-1 to 10-N and the wireless LAN mobile stations 1-1 to 1-N, the radio signal transmitted from the base stations 10-1 to 10-N is blocked by the obstacle, thereby changing the RSSI value and causing the mobile station 1-1 to 1-N to execute the handover process. Consequently, even when the mobile stations 1-1 to 1-N are not moving, the handover process may be frequently executed due to the fluctuating RSSI values.

Since the environmental conditions of the wireless LAN base stations 10-1 to 10-N vary with time, it is difficult to decrease frequency of handovers even if the wireless LAN base stations 10-1 to 10-N are relocated. Accordingly, it is desirable to expand the functions of the wireless LAN mobile station 1-1 to 1 -N to decrease the frequency of handovers.

Patent document 1 (Japanese Patent Application Laid-Open No. 2005-175932) discloses a wireless LAN handover processing system that includes a plurality of wireless LAN base stations and at lease one wireless LAN terminal moving under each of the plurality of wireless LAN base stations. The wireless LAN terminal switches wireless LAN base stations, looking for a stronger reception signal level when a reception signal level lowers, while transmitting and receiving data, and scanning the reception signal level of a wireless LAN base station. Specifically, the wireless LAN terminal voluntarily starts handover when the reception signal level lowers, and establishes communication with another wireless LAN base station providing a stronger reception signal level. Time required for switching wireless LAN base stations is thereby shortened.

Patent document 2 (WO99/34627) discloses a wireless communication device that includes a radio unit connected to a transmitter and receiver antenna, and a control unit comparing either or both of a field intensity level and a link quality measured by the radio unit with threshold values, outputting a handover instruction to the radio unit when the measured field intensity level or the measured link quality is equal to or smaller than corresponding threshold value, and decreasing the threshold value when a handover process performed in accordance with the handover instruction was unsuccessful. A communication quality level is improved because of reduced frequency of handovers when there is no base station available for handover.

Patent document 3 (Japanese Patent Application Laid-Open No. 2005-051416) discloses a radio communication terminal in which a plurality of communication means is communicating with a plurality of communication systems. The radio communication terminal comprises a threshold value setting section setting threshold values of quality determination of signals, which the communication means receives from base stations, for the respective communication means; a determining section determining, based on the threshold values, whether the communication means can perform communication; and a changing section changing threshold values as set by,the threshold value setting means when the determining means determines that at least two communication means can perform communication, and handoff occurs in one of the communication means. The terminal controls the frequency of idle handoff.

Non-patent document 1 (Yukio MITANI and four others, Wireless LAN system, “UNIVERGE WL Series”, NEC Journal of Advanced Technology, 2005, No. 5, Vol. 58, pp. 58-60) discloses an example of a wireless LAN system that is being developed by the present inventors.

Though patent document 1 discloses that a handover process is performed when the reception signal level lowers, a method of handling frequent handovers is not considered.

Patent document 2 discloses that the threshold value is decreased when the handover process was unsuccessful, and the frequency of the handover process is decreased when there is no base station available for the handover process, thereby improving a communication quality. However, it is not considered that the number of handovers in unit time is calculated and the frequency of handovers is decreased based on the calculation result. Moreover, it is not considered to reduce the frequency of handovers without changing a threshold value.

Patent document 3 discloses that a hybrid terminal (a radio communication terminal having a plurality of communication means) capable of preventing an idle handoff while the idle handoff (an operation of changing base stations in a standby mode) frequently occurs. The frequency of handoffs is calculated based on the number of handoffs in the standby mode. However, it is not considered to measure the number of handovers in unit time, and to reduce the frequency of handovers based on the measurement. Moreover, it is not considered to reduce the frequency of handovers without changing a threshold value.

### SUMMARY OF THE INVENTION

In one exemplary aspect, the present specification explains a wireless LAN mobile station, a wireless LAN system, and a method and a program for controlling handover, and decreasing the frequency of handovers of a wireless LAN mobile station.

In order to achieve the above objective, the present embodiments have the following aspects.

A wireless LAN mobile station includes: a received signal strength measuring section that measures the value of a received signal strength indicator; a handover executing section that compares the value of the received signal strength indicator with a threshold value serving as a criterion for executing a handover and executes a handover when the value of the received signal strength indicator is equal to or smaller than the threshold value; a calculating section that calculates the number of handovers in unit time; and a threshold value changing section that changes the threshold value based on the number of handovers.

The threshold value changing section may decrease the threshold value by a predetermined value when the number of handovers is equal to or greater than a predetermined value.

The threshold value changing section may change the threshold value to an initial threshold value or increase the threshold value by a predetermined value when the number of handovers is smaller than a predetermined value after the threshold value is decreased by a predetermined value.

The wireless LAN mobile station may further include a managing section that manages the number of handovers in unit time and a value of received signal strength indicator so that they are correlated with each other, and the threshold value changing section acquires the received signal strength value correlated with the number of handovers, on the basis of the number of handovers, and changes the threshold value to the acquired received signal strength indicator value.

The wireless LAN mobile station may further include a threshold value change determining section that determines whether the threshold value changing section changes the threshold value.

There is also provided a wireless LAN mobile station including: a received signal strength measuring section that measures the value of a received signal strength indicator; a handover executing section that compares the value of the received signal strength indicator with a threshold value serving as a criterion for executing a handover and executes the handover when the value of the received signal strength indicator is equal to or smaller than the threshold value; and a handover execution control section that prohibits the execution of the handover for a predetermined time period even when the received signal strength indicator value becomes equal to or smaller than the threshold value after the handover has been executed.

In the wireless LAN mobile station according to the above aspect of the invention, the wireless LAN mobile station further includes a time setting section that sets the predetermined time period on the basis of a variation amount of the received signal strength indicator value, and the handover execution control section prohibits the execution of the handover for the predetermined time period.

The wireless LAN mobile station may further include an execution determining section that determines whether the handover execution control section prohibits the handover.

There is also provided a wireless LAN system comprising a plurality of wireless LAN base stations and a wireless LAN mobile station communicating with a plurality of wireless LAN base stations, wherein the wireless LAN mobile station includes: a received signal strength measuring section that measures the value of a received signal strength indicator; a handover executing section that compares the value of the received signal strength indicator with a threshold value serving as a criterion for executing a handover and executing the handover when the value of the received signal strength indicator is equal to or smaller than the threshold value; a calculating section that calculates the number of executing the handover in unit time; and a threshold value changing section that changes the threshold value on the basis of the number of handovers.

The wireless LAN mobile station may decrease the threshold value by a predetermined value when the number of handovers is equal to or greater than a predetermined value.

The wireless LAN mobile station may change the threshold value to an initial threshold value or increase the threshold value by a predetermined value when the number of handovers is smaller than a predetermined value after the threshold value is decreased by a predetermined value.

The wireless LAN mobile station may further include a managing section that manages the number of handovers in unit time and a value of received signal strength indicator so that they are correlated with each other, and the wireless LAN mobile station acquires the received signal strength value correlated with the number of handovers, based on the number of handovers and changes the threshold value to the acquired received signal strength indicator value.

The wireless LAN mobile station may further include a threshold value change determining section that determines whether the threshold value changing section changes the threshold value.

There is provided a wireless LAN system comprising a plurality of wireless LAN base stations and a wireless LAN mobile station communicating with the plurality of wireless LAN base stations, wherein the wireless LAN mobile station includes: a received signal strength measuring section that measures the value of a received signal strength indicator; a handover executing section that compares the value of the received signal strength indicator with a threshold value serving as a criterion for executing a handover and executes the handover when the value of the received signal strength indicator is equal to or smaller than the threshold value; and a handover execution control section prohibits the execution of the handover for a predetermined time period even when the received signal strength indicator value becomes equal to or smaller than the threshold value after the handover has been executed.

The wireless LAN base station may include a time setting section that sets the predetermined time period on the basis of a variation amount of the received signal strength indicator value, and the handover execution control section prohibits the execution of the handover for the predetermined time period.

The wireless LAN base station may include an execution determining section that determines whether the handover execution control section prohibits the handover.

There is also provided a method for controlling a handover in a wireless LAN mobile station in which the value of received signal strength indicator is measured, the measured received signal strength indicator value is compared with a threshold value serving as a criterion for executing the handover, and the handover is executed when it is determined that the received signal strength indicator value is equal to or smaller than the threshold value, the method comprising: a calculating step of calculating the number of executing the handover in unit time; and a threshold value changing step of changing the threshold value on the basis of the number of handovers.

In the method of controlling a handover according to the above aspect of the invention, the threshold value changing step is configured to decrease the threshold value by a predetermined value when the number of handovers is equal to or greater than a predetermined value.

At the threshold value changing step, the threshold value may be changed to an initial threshold value or the threshold value may be increased by a predetermined value when the number of handovers is smaller than a predetermined value after the threshold value is decreased by a predetermined value.

The wireless LAN mobile station may include a managing section that manages the number of handovers in unit time and a value of received signal strength indicator so that they are correlated with each other, and at the threshold value changing step, acquires the received signal strength value correlated with the number of handovers is acquired, based on the number of handovers, and the threshold value is changed to the acquired received signal strength indicator value.

The method may further comprise a process including a threshold value change determining step of determining whether at the threshold value changing step, the threshold value is changed.

There is also provided a method for controlling a handover in a wireless LAN mobile station in which the value of received signal strength indicator is measured, the measured received signal strength indicator value is compared with a threshold value serving as a criterion for executing the handover, and the handover is executed when it is determined that the received signal strength indicator value is equal to or smaller than the threshold value, the method comprising a handover execution control step of prohibiting the handover for a predetermined time period even when the received signal strength indicator value becomes equal to or smaller than the threshold value after the handover has been executed.

The method may further comprise a time setting step of setting the predetermined time period based on a variation amount of the measured received signal strength indicator value, and at the handover execution control step, the handover is prohibited for the predetermined time period set in the time setting step.

The method may further comprise an execution determining step of determining whether at the handover execution control step, the handover is prohibited.

There is also provided a computer program for controlling a handover in a wireless LAN mobile station in which the value of received signal strength indicator is measured, the measured received signal strength indicator value is compared with a threshold value serving as a criterion for executing the handover, and the handover is executed when the received signal strength indicator value is equal to or smaller than the threshold value, the program causing a computer to perform: a calculating operation of calculating the number of executing the handovers in unit time; and a threshold value changing operation of changing the threshold value based on the number of handovers.

The threshold value changing operation may decrease the threshold value by a predetermined value when the number of handovers is equal to or greater than a predetermined value.

The threshold value changing operation may change the threshold value to an initial threshold value or increase the threshold value by a predetermined value when the number of handovers is smaller than a predetermined value after the threshold value is decreased by a predetermined value.

The wireless LAN mobile station may include managing section that manages the number of handovers in unit time and a value of received signal strength indicator so that they are correlated with each other, and the threshold value changing operation may acquire the received signal strength value correlated with the number of handovers, based on the number of handovers and change the threshold value to the acquired received signal strength indicator value.

The program may further cause a computer to perform a process including a threshold value change determining operation of determining whether the threshold value changing operation changes the threshold value.

There is also provided a computer program for controlling a handover in a wireless LAN mobile station in which the value of received signal strength indicator is measured, the measured received signal strength indicator value is compared with a threshold value serving as a criterion for executing the handover, and the handover is executed when the received signal strength indicator value is equal to or smaller than the threshold value, the program causing a computer to perform a handover execution control operation of prohibiting the handover for a predetermined time period even when the received signal strength indicator value becomes equal to or smaller than the threshold value after the handover has been executed.

The program may further cause a computer to perform a time setting operation of setting the predetermined time period on the basis of a variation amount of the measured received signal strength indicator value, wherein the handover execution control operation prohibits the execution of the handover for the predetermined time period set in the time setting operation.

The program may further cause a computer to perform an execution determining operation of determining whether the handover execution control operation prohibits the handover.

As described above, the number of handovers in unit time is calculated, and the threshold value serving as a criterion for executing the handover process is changed on the basis of the calculated number of handovers. Accordingly, it is possible to decrease the frequency of handovers.

In addition, the execution of the handover process is prohibited for a predetermined time period even when the received signal strength indicator value becomes equal to or smaller than the threshold value after the handover has been executed. Accordingly, it is possible to decrease the frequency of handovers.

### BRIEF DESCRIPTION OF THE DRAWINGS

FIG. 1 is a schematic diagram showing a configuration of a wireless LAN system;

FIG. 2 is a schematic diagram showing an example of a handover process;

FIG. 3 is a schematic diagram showing a series of operations performed in the process of the handover;

FIG. 4 is a block diagram showing an internal arrangement of wireless LAN base stations 10-1 to 10-N constituting a wireless LAN system;

FIG. 5 is a block diagram showing an internal arrangement of wireless LAN mobile station 1-1 to 1-N constituting the wireless LAN system;

FIG. 6 is a flowchart showing a first control operation performed by the wireless LAN mobile station 1-1 to 1-N;

FIG. 7 is a flowchart showing a second control operation performed by the wireless LAN mobile station 1-1 to 1-N;

FIG. 8 is a diagram showing the arrangement of a management table 208 in which a “number of handovers in unit time” is correlated with a “received signal strength (RSSI) value” serving as a criterion for the wireless LAN mobile station 1-1 to 1-N executing the handover process;

FIG. 9 is a block diagram showing an internal arrangement of the wireless LAN mobile station 1-1 to 1-N constituting the wireless LAN system;

FIG. 10 is a flowchart showing a first control operation performed by the wireless LAN mobile station 1-1 to 1-N;

FIG. 11 is a flowchart showing a second control operation performed by the wireless LAN mobile station 1-1 to 1-N;

FIG. 12 is a block diagram showing an internal arrangement of the wireless LAN mobile station 1-1 to 1-N constituting the wireless LAN system;

FIG. 13 is a flowchart showing control operations performed by the wireless LAN mobile station 1-1 to 1-N; and

FIG. 14 is a diagram showing a relationship between a variation amount of the received signal strength indicator (RSSI) value measured by a received signal strength measuring unit 205 and a time period set in correspondence with the variation amount.

### DETAILED DESCRIPTION OF THE EXEMPLARY EMBODIMENTS

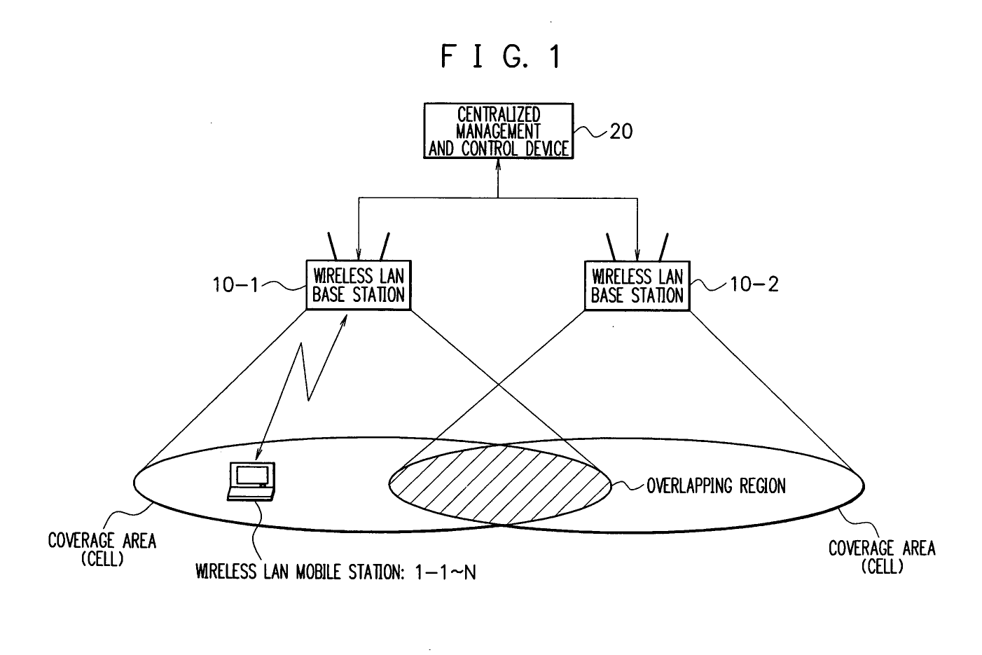

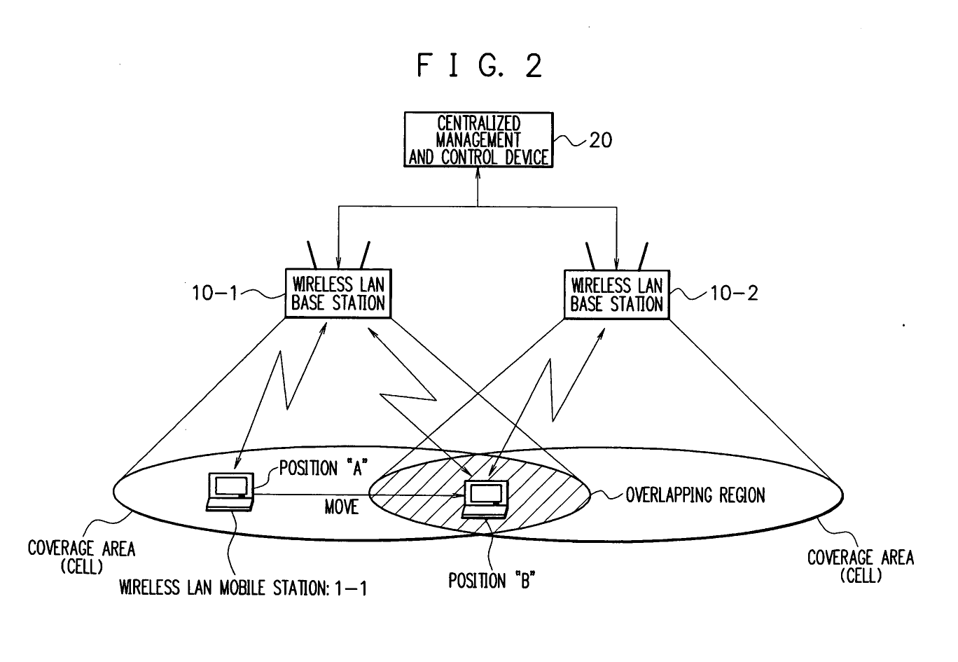

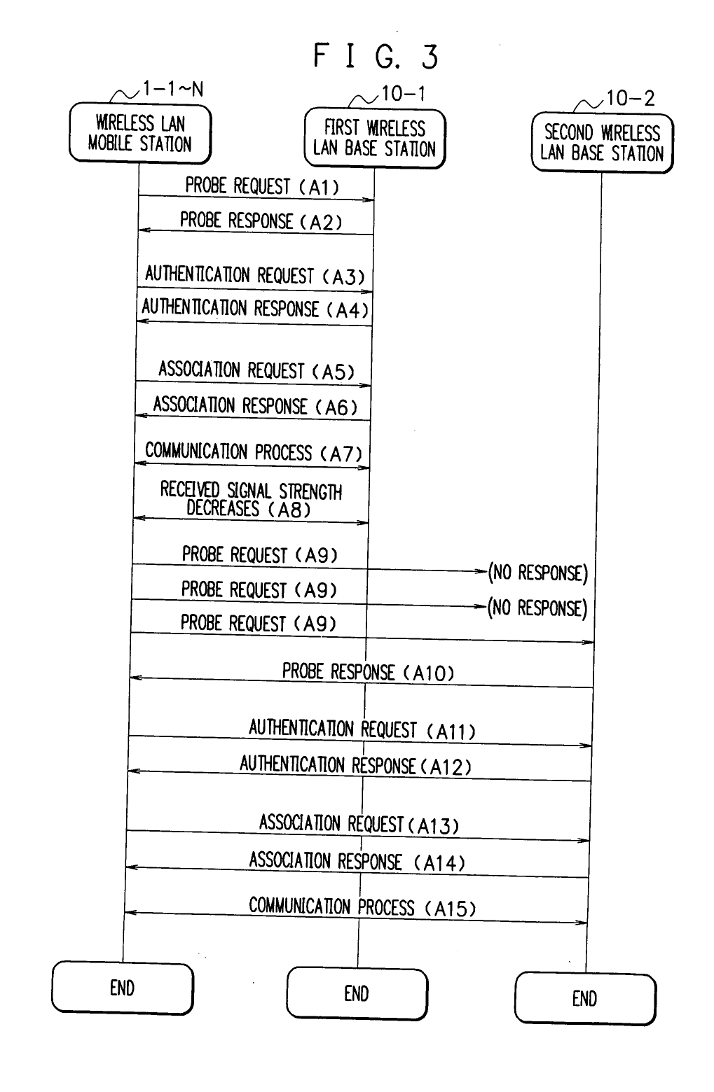

Hereinafter, a wireless LAN system will be described with reference to FIG. 1.

The wireless LAN system includes a plurality of wireless LAN base stations 10-1 to 10-N (N is an arbitrary integer) and wireless LAN mobile stations 1-1 to 1-N (N is also an arbitrary integer not related to the number N of base stations) operating under the wireless LAN base stations 10-1 to 10-N. The mobile stations 1-1 to 1-N perform handover when the value of received signal strength indicator (RSSI) received from the base station 10-1 to 10-N is equal to or smaller than a threshold value serving as a criterion for executing the handover process. In a mobile station, the number of handovers in unit time is measured and the threshold value is changed based on the measured result. In this way, handover is controlled and thus the frequency of handover is reduced.

In addition, the wireless LAN mobile stations 1-1 to 1-N do not perform handovers for a predetermined time even when the value of RSSI becomes equal to or smaller than the threshold value after the handover has been executed. In this way, the frequency of handovers is reduced. Hereinafter, the wireless LAN system in accordance with the embodiments will be described in detail with reference to the accompanying drawings.

### First Embodiment

First, a wireless LAN system is described with reference to FIG. 1.

As shown in FIG. 1, the wireless LAN system includes wireless LAN mobile stations 1-1 to 1-N (N is an arbitrary integer), wireless LAN base stations 10-1 to 10-N, and a centralized management and control device 20.

<Centralized Management and Control Device 20>

The device 20 controls the entire operations of base stations 10-1 to 10-N and manages various settings of respective base stations 10-1 to 10-N.

<Wireless LAN Base Stations 10-1 to 10-N>

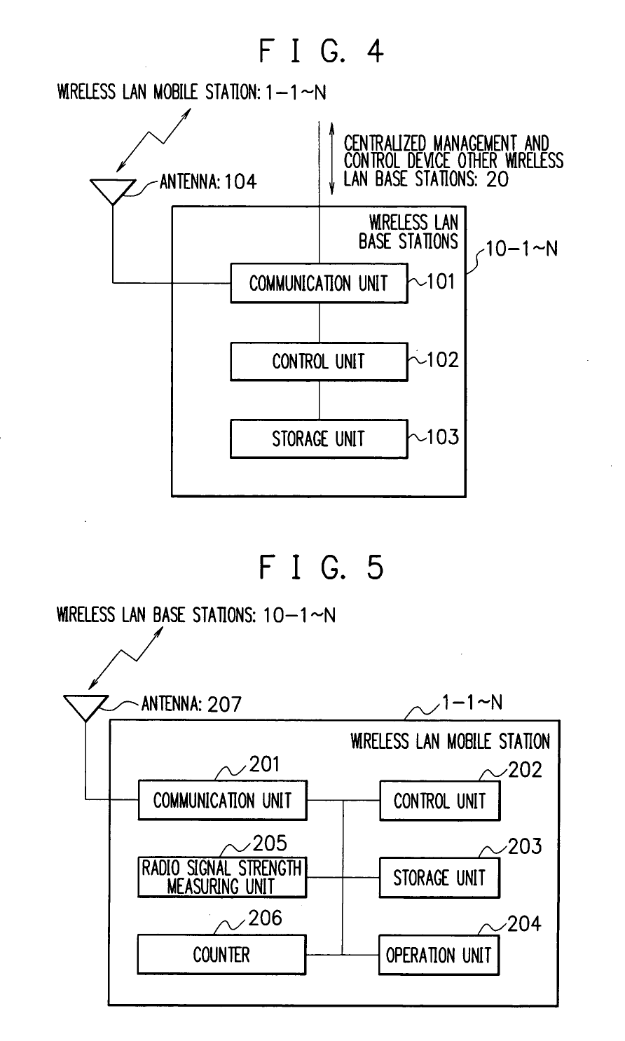

The base stations 10-1 to 10-N transmit and receive information to and from the mobile stations 1-1 to 1-N under the control of the device 20. Hereinafter, the internal arrangement of the base stations 10-1 to 10-N will be described with reference to FIG. 4.

As shown in FIG. 4, each of the base stations 10-1 to 10-N includes a communication unit 101, a control unit 102, a storage unit 103, and an antenna 104.

The unit 101 transmits and receives information to and from the device 20 and establishes a radio link with the mobile stations 1-1 to 1-N through the antenna 104, thereby transmitting and receiving the information at an arbitrary frequency. The unit 101 may transmit and receive information to and from other base stations. The unit 102 controls the entire operations of a base station. The unit 103 stores various settings of the base stations or temporarily stores the information transmitted and received to and from the unit 101. An example of the various settings stored in the unit 103 may include a radio channel identifier and a service set identifier (SSID).

<Wireless LAN Mobile Stations 1-1 to 1-N>

The mobile stations 1-1 to 1-N transmit and receive information to and from the base stations 10-1 to 10-N. Hereinafter, the internal arrangement of one of the wireless LAN mobile stations 1-1 to 1-N will be described with reference to FIG. 5.

As shown in FIG. 5, a wireless LAN mobile station includes a communication unit 201, a control unit 202, a storage unit 203, an operation unit 204, a radio signal strength measuring unit 205, a counter 206, and an antenna 207.

The unit 201 establishes a radio link with the base stations 10-1 to 10-N through the antenna 207, thereby transmitting and receiving the information at an arbitrary frequency. The unit 202 controls the entire operations of the mobile station.

The unit 203 stores various settings of the mobile station or temporarily stores the information transmitted and received to and from the unit 201. A threshold of the RSSI value for determining whether to execute a handover process is also stored in the unit 203.

The unit 204 receives input of information for various settings to be stored in the unit 203 or receives input of command information for controlling various operations of the mobile station.

The unit 205 measures the value of a RSSI of radio signals received by the unit 201.

The counter 206 counts the number of handovers executed in the mobile station and calculates the number of handovers in unit time period based on the counted number of handovers.

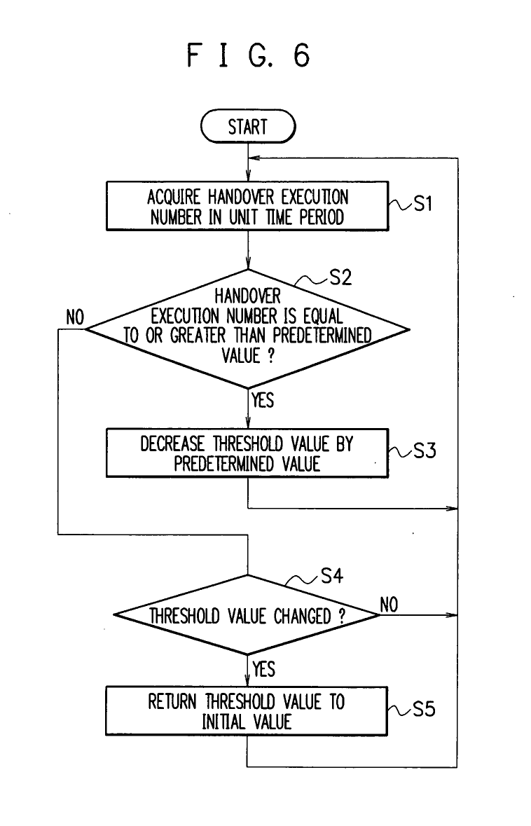

Next, control operations performed by the mobile station will be described with reference to FIG. 6. FIG. 6 is a diagram showing control operations performed at the time of decreasing the frequency of occurrence of the handover process.

First, when the control operations shown in FIG. 6 is performed by the mobile station, it is assumed that the unit 205 monitors the RSSI value of the radio signal received from the base stations 10-1 to 10-N associated with the mobile station 1-1 to 1-N and notifies the unit 202 that the RSSI value became equal to or smaller than a predetermined threshold value stored in the unit 203. Notified from the unit 205, the unit 202 determines that the RSSI value has decreased. Then, the mobile station executes the handover process and performs a scanning operation on other base stations adjacent to the base station currently associated with the mobile station.

The counter 206 counts the number of handovers, calculates the number of handovers in unit time based on the counted number of handovers, and then notifies the unit 202 of the calculated number of handovers in unit time.

First, the unit 202 receives and acquires the number of handovers in unit time from the counter 206 (step S1). Next, the unit 202 compares the acquired number of handovers in unit time with a predetermined value (step S2). When it is determined that the number of handovers in unit time is equal to or greater than the predetermined value (step S2: Yes), the unit 202 subtracts a predetermined value from the threshold value and stores the subtracted value to the unit 203 as a new threshold value serving as the criterion for executing the handover process (step S3).

The unit 202 repeats steps S1 to S3 until it is determined that the number of handovers in unit time is smaller than the predetermined value, gradually decreasing the threshold value. In this way, it is possible to decrease the number of handovers in the wireless LAN mobile stations 1-1 to 1-N.

When it is determined that the number of handovers in unit time is not equal to or greater than the predetermined value (step S2: No), the unit 202 determines whether the threshold value was changed (step S4). When it is determined that the threshold value was changed (step S4: Yes), the unit 202 returns the changed threshold value to an initial threshold value (initial value) (step S5). In this way, it is possible to return the threshold value stored in the unit 203, to the initial value. When it is determined in step S4 that the threshold value has not been changed (step S4: No), the operation of step S1 is performed again.

In FIG. 6, a sequence of operations, that is, “step S1”→“step S2, No”→“step S4, No”, is repeated while the number of handovers in unit time is kept below the predetermined value. In this case, the threshold value is not changed.

When the number of handovers in unit time continues to be equal to or greater than the predetermined value, a sequence of operations, that is, “step S1”→“step S2, Yes”→“step S3” is repeated. In this way, the threshold value is gradually decreased, thereby making it more difficult for handover to occur.

When the number of handovers in unit time increased to a value equal to or greater than the predetermined value, the threshold value is decreased so as to control handover, and then the number of handovers in unit time is decreased to a value smaller than the predetermined value, a sequence of operations, “step S1,”→“step S2, Yes”→“step S3”, is repeated to control handover. When it is determined in step S2 that the number of handovers is smaller than the predetermined value (step S2, No), the threshold value is returned to the initial value in step S5.

As described above, the wireless LAN system is configured to gradually decrease the threshold value when the mobile stations 1-1 to 1-N determine that the number of handovers in unit time calculated by the counter 206 is equal to or greater than the predetermined value. Accordingly, it is possible to control handover and thus decrease the frequency of executing the handover process in the mobile stations 1-1 to 1-N.

Conventionally, since the threshold value, which is stored in the mobile stations 1-1 to 1-N, was set to a fixed value, the RSSI value is likely to decrease to a value equal to or smaller than the threshold value when the RSSI value of the radio signal received from the base stations 10-1 to 10-N varies, whereby frequent handover occurs.

In contrast, according to the present embodiments, the threshold value is gradually decreased when it is determined that the number of handovers in unit time in the wireless LAN mobile stations 1-1 to 1-N is equal to or greater than the predetermined value. Therefore, it is possible to prevent the RSSI value from going below the threshold value even when the RSSI value fluctuates. Consequently, it is possible to control handover and thus decrease the frequency of handovers in the mobile stations 1-1 to 1-N.

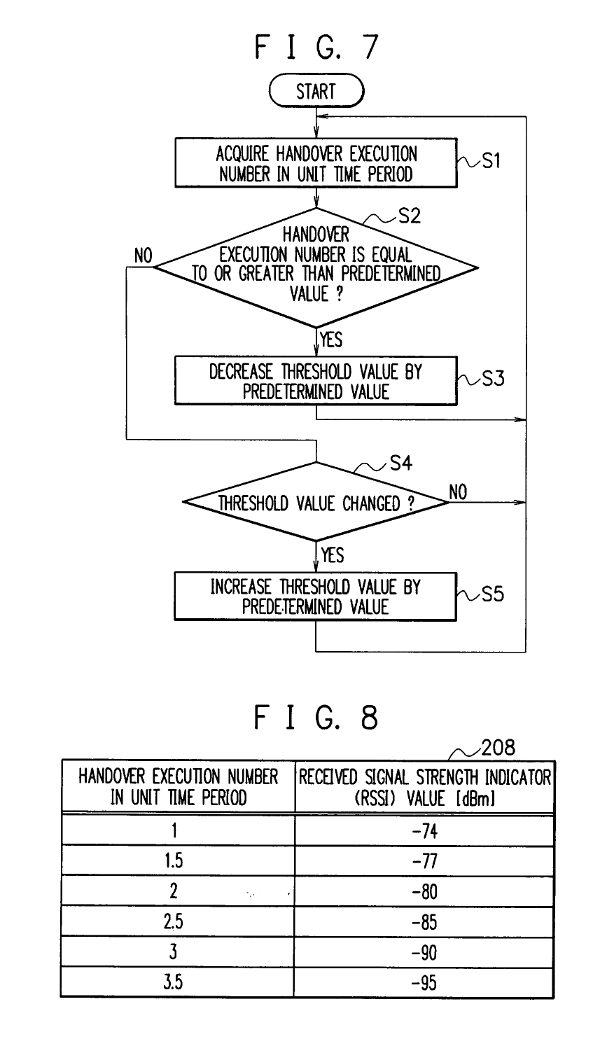

In the series of operations shown in FIG. 6, when it is determined at step S2 that the number of handovers in unit time is equal to or greater than the predetermined value (step S2, Yes), the threshold value is decreased at step S3, and the flow goes back to step S2. When it is determined at step S2 that the number of handovers in unit time is smaller than the predetermined value (step S2, No), the threshold value is returned to the initial value at step S5. The process operations shown in FIG. 6 may be modified in the following manner. As shown in FIG. 7, when it is determined at step S2 that the number of handovers in unit time is equal to or greater than the predetermined value (step S2: Yes), the threshold value is decreased by a predetermined value at step S3, and the flow goes back to step S2. When it is determined at step S2 that the number of handovers in unit time is smaller than the predetermined value (step S2, No), the threshold value is increased by a predetermined value at step S5. When it is determined at step S2 that the number of handovers in unit time is kept smaller than the predetermined value (step S2, No), the threshold value is increased by the predetermined value at step S5 and finally returned to the initial value. In this way, unlike in FIG. 6, in which the threshold value is returned to the initial value at step S5 when it is determined that the number of handovers is smaller than the predetermined value (step S2, No) and the threshold value is changed (step S4, Yes), the threshold value is gradually increased by the predetermined value at step S5 and finally returned to the initial value through a plurality of steps when it is determined that the number of handovers is smaller than the predetermined value (step S2, No) and the threshold value is changed (step S4, Yes), as shown in FIG. 7. Accordingly, it is possible to decrease the number of operations of step S3 that control handover when it is determined that the number of handovers is equal to or greater than the predetermined value (step S2, Yes), compared with the operations in FIG. 6.

The threshold value is increased gradually instead of only one step as shown in FIG. 6 so that the threshold value gradually tends toward the initial value as shown in FIG. 7, thereby increasing a period in which handover does not easily occur. Accordingly, it is possible to further decrease the frequency of handovers.

Although in FIGS. 6 and 7, the counter 206 calculates the number of handovers in unit time, the number of handovers in unit time may be calculated by the unit 202. Moreover, the hardware configuration of the mobile stations 1-1 to 1-N is not particularly limited as long as it can perform the series of operations shown in FIGS. 6 and 7. In addition, the determination of whether to perform the series of operations shown in FIGS. 6 and 7 may be made through the unit 204. Accordingly, it is possible to allow a user to suitably determine whether to perform the series of operations shown in FIGS. 6 and 7.

### Second Embodiment

Next, a second embodiment will be described.

In the wireless LAN system of FIG. 8, each of the mobile stations 1-1 to 1-N includes a management table 208 in which a “number of handovers in unit time” is associated with a “RSSI value” serving as a criterion for executing the handover process. A mobile station 1-1 to 1-N changes the threshold value on the basis of information stored in the table 208.

The table 208 manages the number of handovers in unit time so that a greater number of handovers in unit time is associated with a lower RSSI value. The mobile station searches and acquires the RSSI value correlated with the number of handovers calculated by the counter 206, on the basis of the number of handovers in unit time measured by the counter 206 and the information stored in the table 208 shown in FIG. 8, changes the threshold value to the acquired RSSI value, and stores the changed threshold value in the unit 203. In this case, the threshold value is changed to a lower RSSI value as the number of handovers in unit time measured by the counter 206 becomes higher. Since the threshold value is changed to the lower RSSI value as the number of executing the handover process in unit time in the mobile station gets larger, it is possible to control handover and thus decrease the frequency of handovers. Hereinafter, the wireless LAN system according to the second embodiment will be described with reference to FIGS. 8 to 10. The wireless LAN system may have the same configuration as FIG. 1.

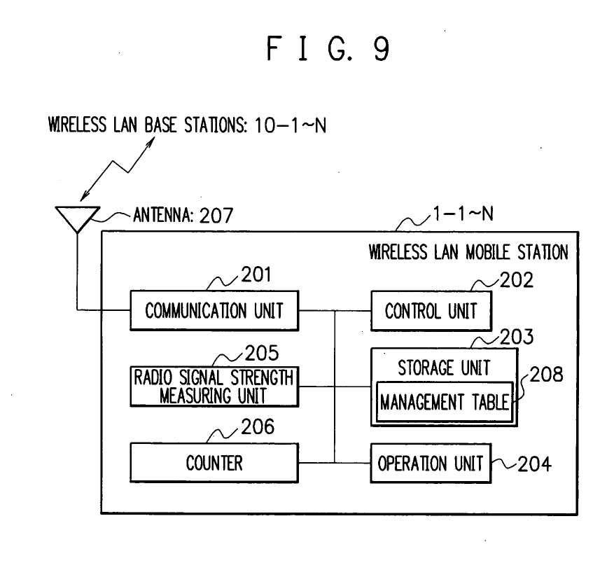

First, the internal arrangement of a wireless LAN mobile station in the wireless LAN system will be described with reference to FIG. 9.

As shown in FIG. 9, the mobile station includes a communication unit 201, a control unit 202, a storage unit 203, an operation unit 204, a radio signal strength measuring unit 205, a counter 206, and an antenna 207. A management table 208 shown in FIG. 8 is stored in the unit 203. Each component of the mobile station has the same function as that of the mobile stations 1-1 to 1-N of the first embodiment.

The table 208 shown in FIG. 8 manages the range of the “number of handovers in unit time” used for changing the threshold value serving as the criterion for executing the handover process so that the threshold value is changed when the number of handovers in unit time calculated by the counter 206 belongs to the range of the “number of handovers in unit time”.

The table 208 manages the “number of handovers in unit time period” so that a greater “number of handovers in unit time” is correlated with a smaller “RSSI value.” In this way, it is possible to change the threshold value to a smaller “RSSI value” as the number of handovers in unit time calculated by the counter 206 increases. The information managed by the table 208 may be suitably modified through an operation of the unit 204.

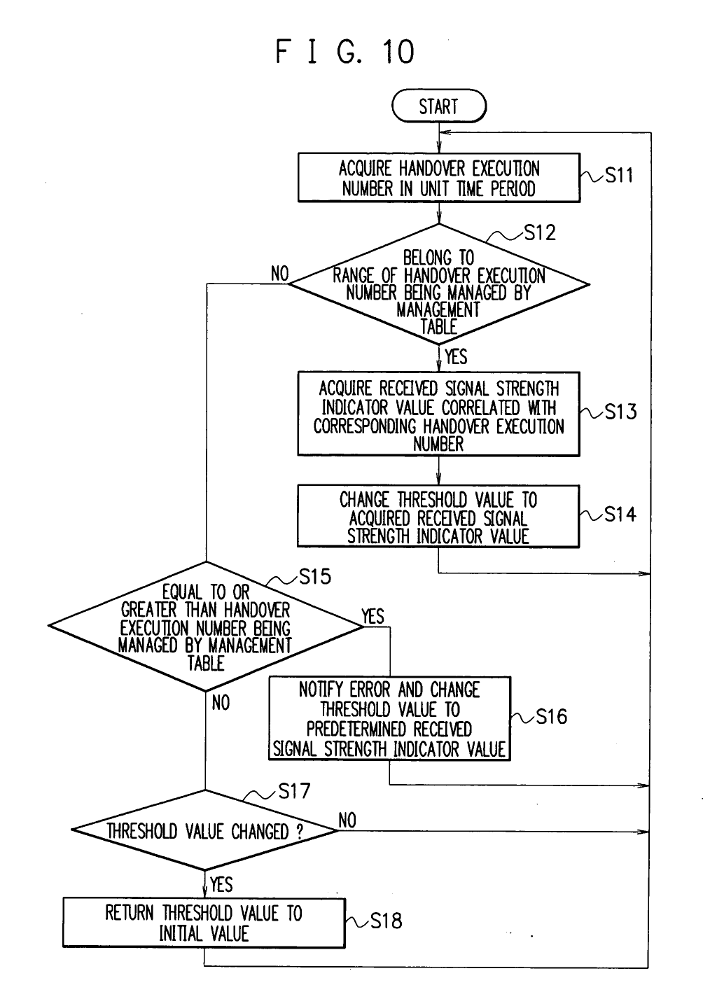

Next, control operations performed by the mobile stations 1-1 to 1-N will be described with reference to FIG. 10. FIG. 10 is a diagram showing control operations performed to reduce the frequency of handovers.

First, similar to the first embodiment, when the control operations shown in FIG. 10 is performed by a mobile station, it is assumed that the unit 205 monitors the RSSI value of the radio signal received from the base stations 10-1 to 10-N associated with the mobile station, and notifies the unit 202 that the RSSI value became equal to or smaller than a predetermined threshold value stored in the unit 203. Notified from the unit 205 that the RSSI value became equal to or smaller than the predetermined threshold value, the unit 202 determines that the RSSI value has decreased. Then, the mobile station executes the handover process and performs a scanning operation on other wireless LAN base stations adjacent to the base station currently associated with the mobile station.

The counter 206 counts the number of handovers, calculates the number of handovers in unit time on the basis of the counted number of handovers, and then notifies the unit 202 of the calculated number of handovers in unit time.

First, the unit 202 receives and acquires the number of handovers in unit time from the counter 206 (step S11). Next, the unit 202 determines whether the number of handovers in unit time acquired in step S11 belongs to the range of the “the number of handovers in unit time” being managed by the table 208, on the basis of the number of handovers in unit time acquired in step S11 and the information stored in the table 208 (step S12).

When the unit 202 determines that the number of handovers in unit time acquired in step S11 belongs to the range of the “number of handovers in unit time” being managed by the table 208 (step S12, Yes), the unit 202 acquires from the table 208 the “RSSI value” correlated with the number of handovers in unit time acquired in step S11 (step S13), changes the threshold value to the acquired “RSSI value,” and stores the changed threshold value in the unit 203 (step S14).

The unit 202 repeats steps S11 to S 14 until it is determined that the number of handovers in unit time calculated by the counter 206 does not belong to the range of the “number of handovers in unit time” being managed by the table 208.

The table 208 manages the “number of handovers in unit time” so that a greater “number of handovers in unit time” is correlated with a smaller “RSSI value.”

The unit 202 acquires a smaller “RSSI value” from the table 208 as the number of handovers in unit time calculated by the counter 206 is larger, and changes the threshold value to the smaller “RSSI value.” In this way, it is possible to decrease the threshold value so that handover does not easily occur, and thus decrease the frequency of handovers.

When the unit 202 acquires the number of handovers in unit time (step S11) and it is determined that the acquired number of handovers in unit time does not belong to the range of the “number of handovers in unit time” being managed by the table 208 (step S12, No), the unit 202 determines whether the number of handovers in unit time acquired in step S11 is equal to or greater than the “number of handovers in unit time” being managed by the table 208 (step S15). When it is determined that the number of handovers in unit time is equal to or greater than the “number of handovers in unit time” being managed by the table 208 (step S15, Yes), the unit 202 determines that the large number of handovers is erroneous and changes the threshold value to a predetermined RSSI value (step S16). Then, the operation of step S11 is performed again. In this case, it is desirable that the predetermined RSSI value used as a new threshold value is set to a value at which handover does not likely occur. In this way, the number of handovers is reduced.

When it is determined that the number of handovers in unit time acquired in step S11 is not equal to or greater than the “number of handovers in unit time” being managed by the table 208 (step S15, No), the unit 202 determines whether the threshold value changed (step S17). When it is determined that the threshold value has been changed (step S17, Yes), the unit 202 changes the changed threshold value to an initial threshold value (initial value) (step S18). In this way, it is possible to return the threshold value stored in the unit 203 to the initial value. When it is determined at step S17 that the threshold value has not been changed (step S17, No), an operation of step S11 is performed with the threshold value unchanged.

As described above, the mobile station includes the table 208 in which the “number of handovers in unit time” is correlated with the “RSSI value.” The mobile station determines whether the number of handovers in unit time in the mobile station belongs to the range of the “number of handovers in unit time” being managed by the table 208. When it is determined that the number of handovers in unit time in the mobile station belongs to the range of the “number of handovers in unit time”, the mobile station acquires from the table 208 the “RSSI value” correlated with the number of handovers in unit time, changes the threshold value to the acquired “RSSI value,” and stores the changed threshold value in the unit 203.

In addition, the table 208 is configured to manage the “number of handovers in unit time” so that a greater “number of handovers in unit time” is correlated with a smaller “RSSI value.” The mobile station acquires the smaller “RSSI value” from the table 208 since the number of handovers in unit time is larger, changes the threshold value to the acquired smaller “RSSI value,” and stores the changed threshold value in the unit 203. In this way, it is possible to decrease the threshold value so as to control handover and thus decrease the frequency of handover.

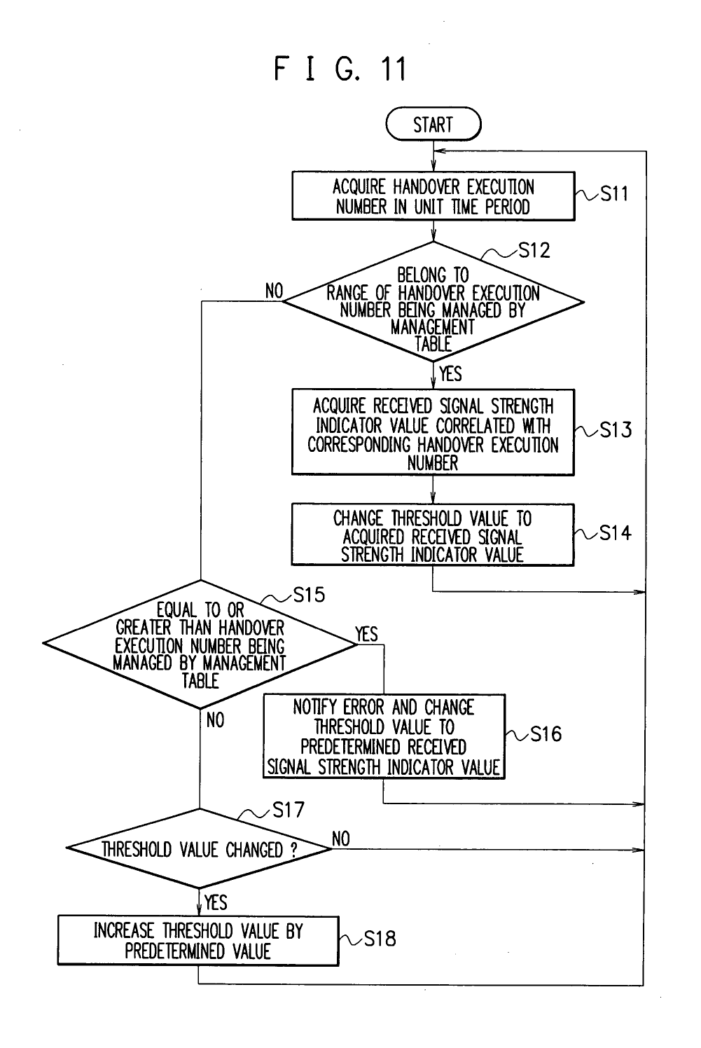

Although in the series of operations shown in FIG. 10, the threshold value is returned to the initial value at step S18, the threshold value may be gradually increased and then finally returned to the initial value at step S18, as shown in FIG. 11.

Although in the above-described of operations shown in FIGS. 10 and 11, the counter 206 calculates the number of handovers in unit time, the number of handovers in unit time may be calculated by the unit 202. Moreover, the hardware configuration of the mobile stations 1-1 to 1-N is not particularly limited as long as it can perform the series of operations shown in FIGS. 10 and 11. In addition, the determination of whether to perform the series of operations shown in FIGS. 10 and 11 may be made through the operation unit 204. Accordingly, it is possible to allow a user to suitably determine whether to perform the series of operations shown in FIGS. 10 and 11.

### Third Embodiment

Next, a third embodiment will be described.

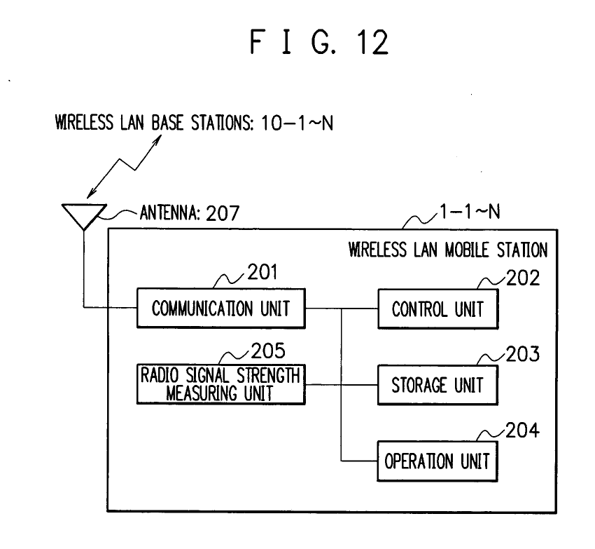

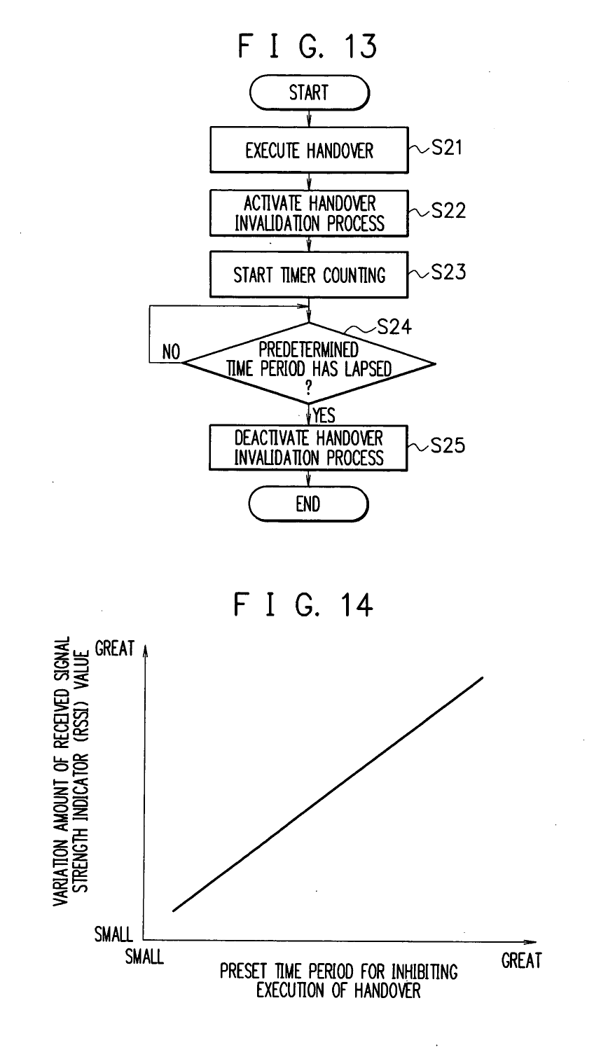

In the wireless LAN system according to the third embodiment, the handover process is not allowed for a predetermined time period even when the RSSI value measured by the radio signal strength measuring unit 205 becomes equal to or smaller than the threshold value stored in the storage unit 203, after the handover has been already executed by a wireless LAN mobile station. Accordingly, it is possible to decrease the frequency handovers in the wireless LAN mobile stations 1-1 to 1-N. Hereinafter, the wireless LAN system according to the third embodiment will be described with reference to FIGS. 12 and 13. The wireless LAN system of the third embodiment may have the same configuration as that of the wireless LAN system of the first and second embodiments shown in FIG. 1.

First, the internal arrangement of one of the wireless LAN mobile stations 1-1 to 1-N in the wireless LAN system will be described with reference to FIG. 12.

As shown in FIG. 12, the mobile station includes a communication unit 201, a control unit 202, a storage unit 203, an operation unit 204, a radio signal strength measuring unit 205, and an antenna 207. The mobile station does not include the counter 206 for calculating the number of handovers. Each component of the mobile station has the same function as that of the mobile stations 1-1 to 1-N of the first and second embodiments.

Next, control operations performed by the mobile station will be described with reference to FIG. 13. FIG. 13 is a diagram showing control operations to reduce the frequency of handovers.

First, similar to the first and second embodiments, when the control operations shown in FIG. 13 is performed by the mobile station, it is assumed that the unit 205 monitors the RSSI value of the radio signal received from the base stations 10-1 to 10-N associated with the mobile station and notifies the unit 202 that the RSSI value became equal to or smaller than a predetermined threshold value stored in the unit 203.

Notified from the unit 205 that the RSSI value became equal to or smaller than the predetermined threshold value, the unit 202 determines that the RSSI value has decreased. Then, the mobile station executes the handover process and performs a scanning operation on other base stations adjacent to the base station currently associated with the mobile station (step S21).

Next, the unit 202 activates an invalidation process for inhibiting handover even when the unit 205 sends information that the RSSI value is equal to or smaller than the predetermined threshold value (step S22), and then start counting of a timer (step S23).

Then, it is determined whether a predetermined time period has elapsed after the timer counting started (step S24). When it is determined that the predetermined time period has elapsed (step S24, Yes), the unit 202 deactivates the invalidation process (step S25) and the series of process operations ends.

In this way, in the mobile stations 1-1 to 1-N, it is possible decrease the frequency of handovers in the mobile stations 1-1 to 1-N by inhibiting the execution of the handover process for a predetermined time period after handover has been executed.

The time period for inhibiting handover may be suitably changed. For example, as shown in FIG. 14, the unit 203 may manage a correspondence table that shows the relationship between a variation amount of the RSSI value and the time period for inhibiting handover. The time period for prohibiting handover, corresponding to the variation amount of the RSSI value measured by the unit 205, is acquired based on the variation amount of the RSSI value measured by the unit 205 and the information stored in the correspondence table shown in FIG. 14, being managed by the unit 203. Then, the acquired time period is used as a new time period for prohibiting handover.

Specifically, the mobile stations 1-1 to 1-N may be configured to manage the history of the RSSI value measured by the unit 205 and calculate the variation amount of the RSSI value before and after handover, on the basis of the history of the RSSI values. Then, the mobile stations 1-1 to 1-N acquire the time period for prohibiting handover corresponding to the variation amount of the RSSI value, on the basis of the calculated variation amount of the RSSI value and the information stored in the correspondence table shown in FIG. 14, being managed by the unit 203, and then changes the time period for prohibiting handover to the acquired time period. When the frequency of handovers is likely to increase as the RSSI value fluctuates often, the time period for prohibiting handover is set to be longer. Meanwhile, when the frequency of handover is likely to decrease as the variation amount of the RSSI value is small, the time period for prohibiting handover is set to be shorter. Accordingly, it is possible to set an optimum time period for prohibiting handover in accordance with the variation amount of the RSSI value. In addition, the determination of whether to perform the series of operations shown in FIG. 13 may be made through the unit 204. Accordingly, it is possible to allow a user to determine whether to perform the processes shown in FIG. 13.

Various changes may be made in the embodiments without departing from the spirit of the invention.

For example, in the above-described control operations in FIGS. 10 and 11, when there is an error notification at step S16, handover may be prohibited only for a predetermined time period in a similar manner to the third embodiment.

For example, the control operations in the mobile stations 1-1 to 1-N of the above-described embodiments may be performed through software such as a computer program instead of a hardware configuration. The program may be recorded on a recording medium such as an optical recording medium, a magnetic recording medium, a magnetic optical recording medium, or a semiconductor storage medium, and then read from the recording medium into a communication device capable of wireless communication, thereby allowing the communication device to execute the above-described control operations. The control operations may be executed by the communication device by reading the program into the communication device from an external device connected to the communication device through a network. The control operations described in the above-described embodiments may be combined to each other.

The wireless LAN mobile stations, the wireless LAN system, and the method and program for controlling a handover may be applied to a communication device capable of wireless communication such as a cellular phone, a PDA (Personal Digital Assistance), or a PC (Personal Computer).

While the invention has been described in terms of several exemplary embodiments, those skilled in the art will recognize that the invention can be practiced with modification within the spirit and scope of the appended claims.

Further, it is noted that Applicant's intent is to encompass equivalents of all claim elements, even if amended later during prosecution

What is claimed is:

1. A wireless LAN mobile station comprising:
a received signal strength measuring section that measures the value of a received signal strength indicator;
a handover executing section that compares the value of the received signal strength indicator with a threshold value serving as a criterion for executing a handover and executes a handover when the value of the received signal strength indicator is equal to or smaller than the threshold value; and
a handover execution section that selectively reduces a number of handovers that would normally occur with said threshold value.

2. The wireless LAN mobile station of claim 1, wherein said handover execution section comprises:
a calculating section that calculates a number of handovers in a unit time; and
a threshold value changing section that changes the threshold value based on the number of handovers.

3. The wireless LAN mobile station according to claim 2, wherein the threshold value changing section decreases the threshold value by a predetermined value when the number of handovers is equal to or greater than a predetermined value.

4. The wireless LAN mobile station according to claim 3, wherein the threshold value changing section changes the threshold value to an initial threshold value or increase the threshold value by a predetermined value when the number of handovers is smaller than a predetermined value after the threshold value is decreased by a predetermined value.

5. The wireless LAN mobile station according to claim 1, further comprising managing section that manages the number of handovers in unit time and a value of received signal strength indicator so that they are correlated with each other,
wherein the threshold value changing section acquires the received signal strength indicator value correlated with the number of handovers, based on the number of handovers and changes the threshold value to the acquired received signal strength indicator value.

6. The wireless LAN mobile station according to claim 1, further comprising a threshold value change determining section that determines whether the threshold value changing section changes the threshold value.

7. The wireless LAN mobile station of claim 1, wherein said handover execution control section prohibits the handover for a predetermined time even when the received signal strength indicator value becomes equal to or smaller than the threshold value after the handover has been executed.

8. The wireless LAN mobile station according to claim 7, further comprising a time setting section that sets the predetermined time period based on a variation amount of the received signal strength indicator value,
wherein the handover execution control section prohibits the handover for the predetermined time period.

9. The wireless LAN mobile station according to claim 7, further comprising an execution determining section that determines whether the handover execution control section prohibits the handover.

10. A wireless LAN system comprising a plurality of wireless LAN base stations, and a wireless LAN mobile station communicating with the plurality of wireless LAN base stations, wherein the wireless LAN mobile station comprises:
a received signal strength measuring section that measures a value of a received signal strength indicator;
a handover executing section that compares the value of the received signal strength indicator with a threshold value serving as a criterion for executing a handover and executes the handover when the value of the received signal strength indicator is equal to or smaller than the threshold value;
a calculating section that calculates a number of handovers in a unit time; and
a threshold value changing section that changes the threshold value based on the number of handovers.

11. The wireless LAN system according to claim 10, wherein the wireless LAN mobile station decreases the threshold value by a predetermined value when the number of handovers is equal to or greater than a predetermined value.

12. The wireless LAN system according to claim 11, wherein the wireless LAN mobile station changes the threshold value to an initial threshold value or increases the threshold value by a predetermined value when the number of handovers is smaller than a predetermined value after the threshold value is decreased by a predetermined value.

13. The wireless LAN system according to claim 10, wherein the wireless LAN mobile station further comprises a managing section that manages the number of handovers in unit time and the value of received signal strength indicator so that they are correlated with each other,
wherein the wireless LAN mobile station acquires the received signal strength value correlated with the number of handovers, based on the number of handovers and changes the threshold value to the acquired received signal strength indicator value.

14. The wireless LAN system according to claim 10, wherein the wireless LAN mobile station further comprises a threshold value change determining section that determines whether the threshold value changing section changes the threshold value.

15. A wireless LAN system comprising a plurality of wireless LAN base stations, and a wireless LAN mobile station communicating with a plurality of wireless LAN base stations, wherein the wireless LAN mobile station comprises:
a received signal strength measuring section that measures a value of a received signal strength indicator;
a handover executing section that compares the value of the received signal strength indicator with a threshold value serving as a criterion for executing a handover and executes the handover when the value of the received signal strength indicator is equal to or smaller than the threshold value; and
a handover execution control section that prohibits the handover for a predetermined time period, even when the received signal strength indicator value becomes equal to or smaller than the threshold value after the handover has been executed by the handover executing section.

16. The wireless LAN system according to claim 15,
wherein the wireless LAN base station includes a time setting section that sets the predetermined time period based on a variation amount of the received signal strength indicator value, and
wherein the handover execution control section prohibits the handover for the predetermined time period set by the time setting section.

17. The wireless LAN system according to claim 15,
wherein the wireless LAN base station includes an execution determining section that determines whether the handover execution control section prohibits the handover.

18. A method for controlling a handover in a wireless LAN mobile station in which the value of received signal strength indicator is measured, the measured received signal strength indicator value is compared with a threshold value serving as a criterion for executing the handover, and the handover is executed when the received signal strength indicator value is equal to or smaller than the threshold value, the method comprising:
a calculating step of calculating a number of a handovers in a unit time; and
a threshold value changing step of changing the threshold value based on the number of handovers.

19. The method according to claim 18, wherein at the threshold value changing step the threshold value is decreased by a predetermined value when the number of handovers is equal to or greater than a predetermined value.

20. The method according to claim 19, wherein at the threshold value changing step, the threshold value is changed to an initial threshold value or the threshold value is increased by a predetermined value when the number of handovers is smaller than a predetermined value after the threshold value is decreased by a predetermined value.

21. The method according to claim 18,
wherein the wireless LAN mobile station includes a managing section that manages the number of handovers in unit time and a value of received signal strength indicator so that they are correlated with each other, and
wherein, at the threshold value changing step, the received signal strength value correlated with the number of handovers is acquired, based on the number of handovers, and the threshold value is changed to the acquired received signal strength indicator value.

22. The method according to claim 18, comprising a process including a threshold value change determining step of determining whether the threshold value is changed at the threshold value changing step.

23. A method for controlling a handover in a wireless LAN mobile station in which the value of received signal strength indicator is measured, the measured received signal strength indicator value is compared with a threshold value serving as a criterion for executing the handover, and the handover is executed when the received signal strength indicator value is equal to or smaller than the threshold value,
the method comprising a handover execution control step of prohibiting the handover for a predetermined time period even when the received signal strength indicator value becomes equal to or smaller than the threshold value after the handover has been executed.

24. The method according to claim 23,
wherein the method further comprises a time setting step of setting the predetermined time period based on a variation amount of the measured received signal strength indicator value, and
wherein, at the handover execution control step, the handover is prohibited for the predetermined time period set in the time setting step.

25. The method according to claim 23, further comprising an execution determining step of determining whether the handover is prohibited at the handover execution control step.

26. A computer program tangibly embodied as machine-readable instructions in a medium, for controlling a handover in a wireless LAN mobile station in which a value of received signal strength indicator is measured, the measured received signal strength indicator value is compared with a threshold value serving as a criterion for executing the handover, and the handover is executed when the received signal strength indicator value is equal to or smaller than the threshold value, the program causing a computer to perform:
a calculating operation of calculating a number of executing the handover in a unit time; and
a threshold value changing operation of changing the threshold value based on the number of handovers.

27. The computer program according to claim 26, wherein at the threshold value changing operation the threshold value is decreased by a predetermined value when the number of handovers is equal to or greater than a predetermined value.

28. The computer program according to claim 27, wherein at the threshold value changing operation, the threshold value is changed to an initial threshold value or the threshold value is increased by a predetermined value when the number of handovers is smaller than a predetermined value after the threshold value is decreased by a predetermined value.

29. The computer program according to claim 28, wherein the wireless LAN mobile station includes a managing section that manages the number of handovers in unit time and the value of received signal strength indicator so that they are correlated with each other, and
wherein at the threshold value changing operation, the received signal strength indicator value correlated with the number of handovers is obtained, based on the number of handovers, and the threshold value is changed to the acquired received signal strength indicator value.

30. The computer program according to claim 26, further causing the computer to perform a threshold value change determining operation of determining whether the threshold value is changed at the threshold value changing operation.

31. A computer program tangibly embodied as machine-readable instructions in a medium, for controlling a handover in a wireless LAN mobile station in which the value of received signal strength indicator is measured, the measured received signal strength indicator value is compared with a threshold value serving as a criterion for executing the handover, and the handover is executed when the received signal strength indicator value is equal to or smaller than the threshold value,
the program causing a computer to perform a handover execution control operation of prohibiting the handover for a predetermined time period, even when the received signal strength indicator value becomes equal to or smaller than the threshold value after the handover has been executed.

32. The computer program according to claim 31,
the program further causing the computer to perform a time setting operation of setting the predetermined time period based on a variation amount of the measured received signal strength indicator value, and
wherein, at the handover execution control operation, the handover is prohibited for the predetermined time period set in the time setting operation.

33. The computer program according to claim 31, the program further causing the computer to perform an execution determining operation of determining whether the handover is to be prohibited at the handover execution control operation.
